(19) United States
(12) Patent Application Publication
(10) Pub. No.: US 2006/0050058 A1
(43) Pub. Date: Mar. 9, 2006

(54) Optical mouse structure

(75) Inventor: Chi-Chun Chu, Toufen Township (TW)

Correspondence Address: BACON & THOMAS, PLLC, 625 SLATERS LANE, FOURTH FLOOR, ALEXANDRIA, VA, 22314, US

(73) Assignee: Sunplus Technology Co., Ltd., Hsinchu (TW)

(21) Appl. No.: 11/055,595

(22) Filed: Feb. 11, 2005

(30) Foreign Application Priority Data
Sep. 9, 2004 (TW) 093127293

(51) Int. Cl. G09G 5/08

(52) U.S. Cl. 345/166

(57) ABSTRACT

An improved optical mouse structure, which has a housing and a circuit board. The housing consists of an upper cover and a base. The base has a transparent bottom. The circuit board is arranged fixedly in the housing and has an integrated circuit with a receiving section. One side of the integrated circuit has an extended arm. A light source is arranged on the extended arm to provide the optical mouse with a light. The light crosses the transparent bottom of the base by a first predetermined angle. A lens is arranged below the integrated circuit. The lens has a convex. The convex has an upper surface aligned with the receiving section of the integrated circuit and a lower surface aligned with an area where the light source irradiates on the transparent bottom of the base.

### BACKGROUND OF THE INVENTION

1. Field of the Invention

The invention relates to an improved optical mouse structure and, more particularly, to an improved optical mouse structure with all-in-one lens and sensitive integrated circuit.

2. Description of Related Art

FIG. 1 is an exploded view of a typical optical mouse. As shown in FIG. 1, the typical optical mouse includes a housing 1, a circuit board 2, a lens set 3 and a barrier layer 4. The housing 1 consists of an upper cover 11 and a base 12 with a window 121. The circuit board 2 is fixedly arranged in the housing 1. A sensor 21 with a receiving section 211 is arranged on the circuit board 2. A vertical cavity surface emitting laser (VCSEL) or light emitting diode (LED) is arranged adjacent to one end of the sensor 21 on a plane the same as the receiving section 211. The receiving section 211 of the sensor 21 is aligned with the window 121.

The lens set 3 with a convex 31 is arranged on the base 12 of the housing 1. A channel 32 is arranged close to the convex 31. The center of one end of the channel 32 has a refraction portion 321. The convex 31 has two surfaces aligned with the receiving section 211 of the sensor 21 and the window 121 respectively. Also, one opening of the channel 32 is aligned with the VCSEL or LED 22.

Because the optical mouse typically moves on a mouse pad and arranges the window 121 in the base, it may cause the problem of electrostatic damage (ESD). To overcome this, the barrier layer 4 is arranged between the lens set 3 and the window 121. The barrier layer 4 can be a glass. Such a structure can overcome the ESD problem but increase the manufacturing and assembling cost.

Therefore, it is desirable to provide an improved structure to mitigate and/or obviate the aforementioned problems.

### SUMMARY OF THE INVENTION

The object of the invention is to provide an improved optical mouse structure, which can overcome the ESD problem and reduce the manufacturing and assembling cost.

In accordance with one aspect of the present invention, there is provided an improved optical mouse structure. The structure includes a housing and a circuit board. The housing consists of an upper cover and a base. The base has a transparent bottom. The circuit board is arranged fixedly in the housing and has an integrated circuit with a receiving section. One side of the integrated circuit has an extended arm. A light source is arranged on the extended arm to provide the optical mouse with a light. The light crosses the transparent bottom of the base by a first predetermined angle. A lens is arranged below the integrated circuit. The lens has a convex. The convex has an upper surface aligned with the receiving section of the integrated circuit and a lower surface aligned with an area where the light source irradiates on the transparent bottom of the base.

In accordance with another aspect of the present invention, there is provided an improved optical mouse structure. The structure includes a housing and a circuit board. The housing consists of an upper cover and a base, the base having a bottom with a transparent window formed of a transparent material. The circuit board is arranged fixedly in the housing, which has an integrated circuit with a receiving section and a lens arranged below the integrated circuit, wherein one side of the integrated circuit has an extended arm and a light source arranged on the extended arm to provide with a light crossing the transparent window of the bottom of the base by a first predetermined angle, and the lens has a convex aligning its upper surface with the receiving section of the integrated circuit and aligning its lower surface with an area where the light source irradiates on the transparent bottom of the base; wherein the transparent window is located at the intersection of the base and the light of the light source

Other objects, advantages, and novel features of the invention will become more apparent from the following detailed description when taken in conjunction with the accompanying drawings.

### BRIEF DESCRIPTION OF THE DRAWINGS

FIG. 1 is an exploded view of a conventional optical mouse;

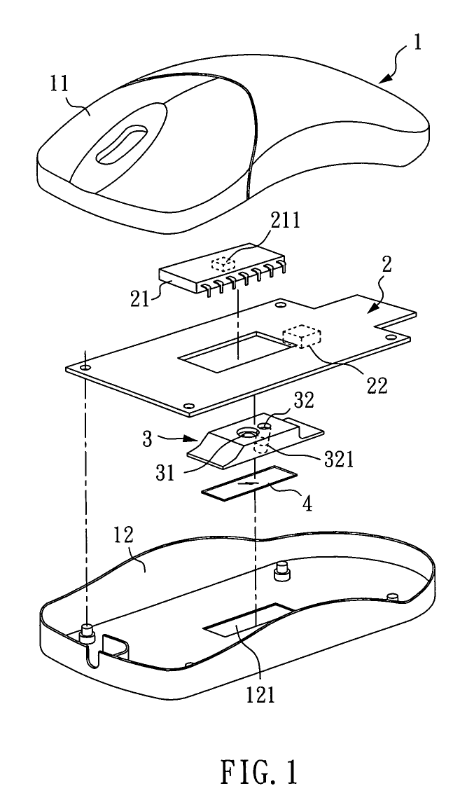

FIG. 2 is an exploded view of an improved optical mouse structure in accordance with the invention;

FIG. 3 is an exploded view of another improved optical mouse structure in accordance with the invention;

FIG. 4 is a schematic graph of a reflective path of FIG. 2 in accordance with the invention; and

FIG. 5 is a schematic graph of a reflective path of FIG. 3 in accordance with the invention.

### DETAILED DESCRIPTION OF THE PREFERRED EMBODIMENT

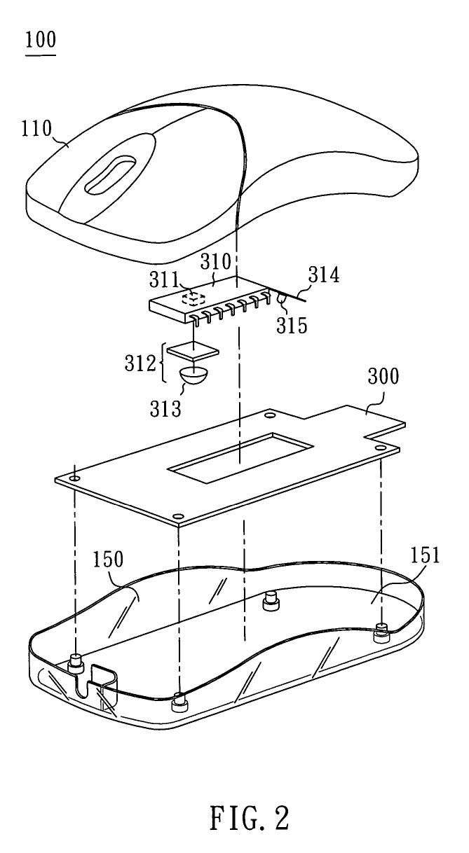

FIG. 2 is an exploded view of an improved optical mouse structure in accordance with the invention. As shown, the structure includes a housing 100 and a circuit board 300. The housing 100 consists of an upper cover 110 and a base 150. The base 150 has a bottom 151 formed of a transparent material. The circuit board 300 is arranged fixedly in the housing 100 and has an integrated circuit 310 with a receiving section 311. One side of the integrated circuit 310 has an extended arm 314. A light source 315 is arranged on the extended arm 314 to provide the optical mouse with a light. A lens 312 is arranged below the integrated circuit 310. The lens 312 has a convex 313. The convex 313 has an upper surface aligned with the receiving section 311 of the integrated circuit 310 and a lower surface aligned with an area where the light source irradiates on the bottom 151 of the base 150.

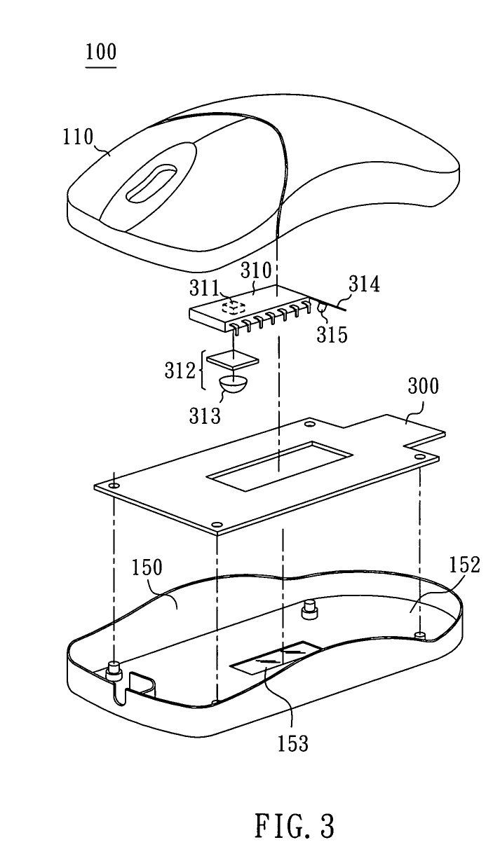

The entire bottom 151 is formed of a transparent material as an all-in-one form. The transparent material can be a glass or transparent plastic. Alternately, as shown in FIG. 3, a transparent window 153 is arranged on an area of the bottom 151 where the light source irradiates on the bottom 151.

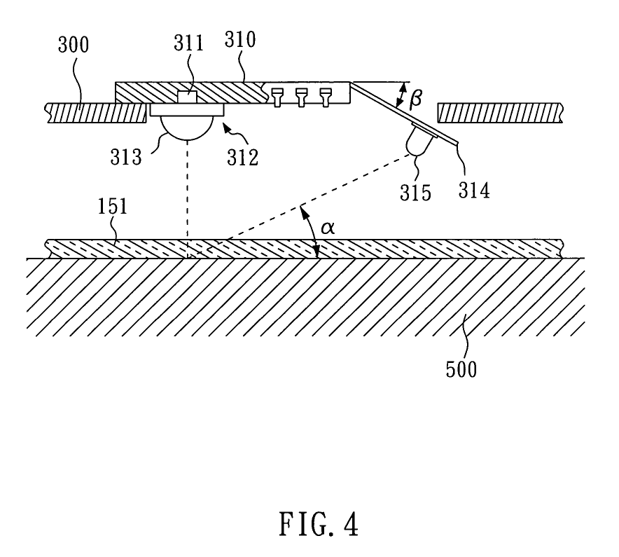

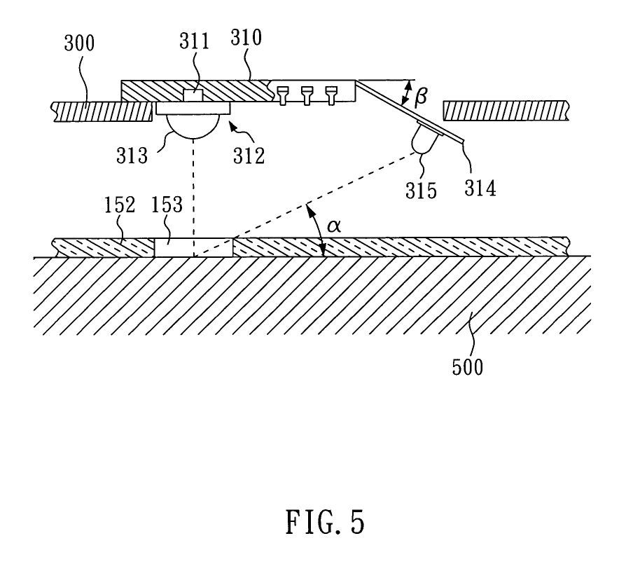

FIG. 4 is a schematic graph of a reflective path of FIG. 2 in accordance with the invention. As shown, the light source 315 can be a light emitting diode (LED) or vertical cavity surface emitting laser (VCSEL). A light of the light source 315 crosses a reflective plane 500 of a mouse pad by a first predetermined angle α. Namely, the first angle α is an included angle of the light of the light source 315 and the reflective plane 500. Preferably, the first angle α is ranged from 20 to 30 degrees. The integrated circuit 310, the extended arm 314 and the lens 312 are integral as an all-in-one form during packaging the integrated circuit 310. The extended arm 314 and a horizontal plane of the integrated circuit 310 form a second predetermined angle β. Preferably, the second angle β is ranged from 60 to 70 degrees. The optical mouse in use irradiates a light through the light source 315. The light is incident to the transparent bottom 121 of the base 150 and irradiates on the reflective plane 500 (desk or mouse pad). In this housing, the light is reflected upwardly and collected by the convex 313. Next, the light collected travels to the receiving section 311. FIG. 5 is a schematic graph of a reflective path of FIG. 3 in accordance with the invention. As compared to FIG. 4, the difference is only at the bottom 152 with the transparent window 153.

In view of the foregoing, it is known that the inventive base 150 has the bottom 151 formed of a transparent material as an all-in-one form, which can overcome the prior ESD problem. In addition, during packaging the integrated circuit 310, the integrated circuit 310, the extended arm 314 and the lens 312 are integral as an all-in-one form, which can reduce the mouse manufacturing and assembling cost.

Although the present invention has been explained in relation to its preferred embodiment, it is to be understood that many other possible modifications and variations can be made without departing from the spirit and scope of the invention as hereinafter claimed.

What is claimed is:

1. An improved optical mouse structure, comprising:
a housing, which consists of an upper cover and a base having a bottom formed of transparent material;
a circuit board arranged fixedly in the housing, which has an integrated circuit with a receiving section and a lens arranged below the integrated circuit, wherein one side of the integrated circuit has an extended arm and a light source arranged on the extended arm to provide with a light crossing the bottom of the base by a first predetermined angle, and the lens has a convex aligning its upper surface with the receiving section of the integrated circuit and aligning its lower surface with an area where the light source irradiates on the transparent bottom of the base.

2. The structure as claimed in claim 1, wherein the light source is a light emitting diode (LED) or vertical cavity surface emitting laser (VCSEL).

3. The structure as claimed in claim 1, wherein the transparent material is a glass or transparent plastic.

4. The structure as claimed in claim 1, wherein the extended arm and a horizontal plane of the integrated circuit form a second predetermined angle.

5. The structure as claimed in claim 1, wherein the first predetermined angle is ranged from 20 to 30 degrees.

6. The structure as claimed in claim 4, wherein the second predetermined angle is ranged from 60 to 70 degrees.

7. The structure as claimed in claim 1, wherein the integrated circuit, the extended arm and the lens are integral as an all-in-one form.

8. An improved optical mouse structure, comprising:
a housing, which consists of an upper cover and a base, the base having a bottom with a transparent window formed of a transparent material; and
a circuit board arranged fixedly in the housing, which has an integrated circuit with a receiving section and a lens arranged below the integrated circuit, wherein one side of the integrated circuit has an extended arm and a light source arranged on the extended arm to provide with a light crossing the transparent window of the bottom of the base by a first predetermined angle, and the lens has a convex aligning its upper surface with the receiving section of the integrated circuit and aligning its lower surface with an area where the light source irradiates on the transparent bottom of the base;
wherein the transparent window is located at the intersection of the base and the light of the light source.

9. The structure as claimed in claim 8, wherein the light source is a light emitting diode (LED) or vertical cavity surface emitting laser (VCSEL).

10. The structure as claimed in claim 8, wherein the transparent material is a glass or transparent plastic.

11. The structure as claimed in claim 8, wherein the extended arm and a horizontal plane of the integrated circuit form a second predetermined angle.

12. The structure as claimed in claim 8, wherein the first predetermined angle is ranged from 20 to 30 degrees.

13. The structure as claimed in claim 11, wherein the second predetermined angle is ranged from 60 to 70 degrees.

14. The structure as claimed in claim 8, wherein the integrated circuit, the extended arm and the lens are integral as an all-in-one form.
